(19) United States
(12) Patent Application Publication
(10) Pub. No.: US 2014/0245181 A1
(43) Pub. Date: Aug. 28, 2014

(54) METHODS AND SYSTEMS FOR INTERACTING WITH AN INFORMATION DISPLAY PANEL

(71) Applicant: SHARP LABORATORIES OF AMERICA, INC., Camas, WA (US)

(72) Inventor: Basil Isaiah Jesudason, Portland, OR (US)

(73) Assignee: SHARP LABORATORIES OF AMERICA, INC., Camas, WA (US)

(21) Appl. No.: 13/776,499

(22) Filed: Feb. 25, 2013

(51) Int. Cl. G06F 3/0481

(52) U.S. Cl. CPC G06F 3/0481
USPC 715/753

(57) ABSTRACT

Aspects of the present invention are related to methods and systems for interacting with an information display panel. An interactive display system may comprise an information display panel (IDP), a server system and a touch-enabled mobile device. Touch gestures, for example, single-touch gestures, multi-touch gestures and other gestures, performed on the touch-enabled mobile device may control the content displayed on the IDP. Touch-gesture information describing a touch gesture performed on the touch-enabled mobile device may be communicated to the server system from the touch-enabled mobile device. The server system may translate the received touch-gesture information into IDP-domain touch-gesture information specific to the IDP. The IDP-domain touch-gesture information may be communicated from the server system to the IDP. The IDP may decode the received IDP-domain touch-gesture information and may effectuate changes to content displayed on the IDP in accordance with the decoded IDP-domain touch-gesture information.

### FIELD OF THE INVENTION

Embodiments of the present invention relate generally to methods and systems for interacting with an information display panel and, in particular, to methods and systems for interacting, with an information display panel, using a multi-touch mobile device.

### BACKGROUND

Digital signage using an information display panel (IDP) is becoming increasingly prevalent. An IDP may be placed in a public area for showing announcements, displaying adverts or playing other image and/or video content. Often, an IDP may be mounted in a hard-to-reach location and/or may not have a touch panel. However, there is an increasing expectation, by viewers, to be able to interact with an IDP. Therefore, methods and systems for interacting with an IDP may be desirable.

### SUMMARY

Some embodiments of the present invention relate to methods and systems for interacting with an information display panel.

According to a first aspect of the present invention, an interactive display system may comprise an information display panel (IDP), a server system and a touch-enabled mobile device.

According to a second aspect of the present invention, touch gestures, for example, single-touch gestures, multi-touch gestures and other gestures, performed on the touch-enabled mobile device may control the content displayed on the IDP.

According to a third aspect of the present invention, touch-gesture information describing a touch gesture performed on the touch-enabled mobile device may be communicated to the server system from the touch-enabled mobile device. The server system may translate the received touch-gesture information into IDP-domain touch-gesture information specific to the IDP. The IDP-domain touch-gesture information may be communicated from the server system to the IDP. The IDP may decode the received IDP-domain touch-gesture information and may effectuate changes to content displayed on the IDP in accordance with the decoded IDP-domain touch-gesture information.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture illustrating exemplary embodiments of the present invention comprising a system for interacting with an IDP, wherein the system comprises an IDP, a server system, on which resides an interactive-session service, and a touch-enabled mobile device;

FIG. 2 is a chart showing exemplary embodiments of the present invention comprising an interactive-session service, wherein the interactive-session service receives touch and/or gesture information from a touch-enabled mobile device, translates the received touch and/or gesture information to IDP-specific information and sends the IDP-specific information to the IDP;

FIG. 3 is a chart depicting exemplary embodiments of the present invention comprising an IDP, wherein the IDP receives IDP-specific touch information from an interactive-session service and effectuates content changes based on the received IDP-specific touch information; and

FIGS. 4A-4D are a chart depicting exemplary embodiments of the present invention comprising an interactive-session service, a touch-enabled mobile device and an IDP, wherein touch and/or gesture information for interacting with the IDP is received on the touch-enabled mobile device, sent to the interactive-session service, where it is translated into IDP-domain information and sent to the IDP, whereat it effectuates content changes.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods, systems and apparatus of the present invention is not intended to limit the scope of the invention, but it is merely representative of the presently preferred embodiments of the invention.

Elements of embodiments of the present invention may be embodied in hardware, firmware and/or a non-transitory computer program product comprising a computer-readable storage medium having instructions stored thereon/in which may be used to program a computing system. While exemplary embodiments revealed herein may only describe one of these forms, it is to be understood that one skilled in the art would be able to effectuate these elements in any of these forms while resting within the scope of the present invention.

Although the charts and diagrams in the figures may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence. It is understood by those with ordinary skill in the art that a non-transitory computer program product comprising a computer-readable storage medium having instructions stored thereon/in which may be used to program a computing system, hardware and/or firmware may be created by one of ordinary skill in the art to carry out the various logical functions described herein.

Digital signage using an information display panel (IDP) is becoming increasingly prevalent. An IDP may be placed in a public area for showing announcements, displaying adverts or playing other image and/or video content. Often, an IDP may be mounted in a hard-to-reach location and/or may not have a touch panel. However, there is an increasing expectation, by viewers, to be able to interact with an IDP. Therefore, methods and systems for interacting with an IDP may be desirable.

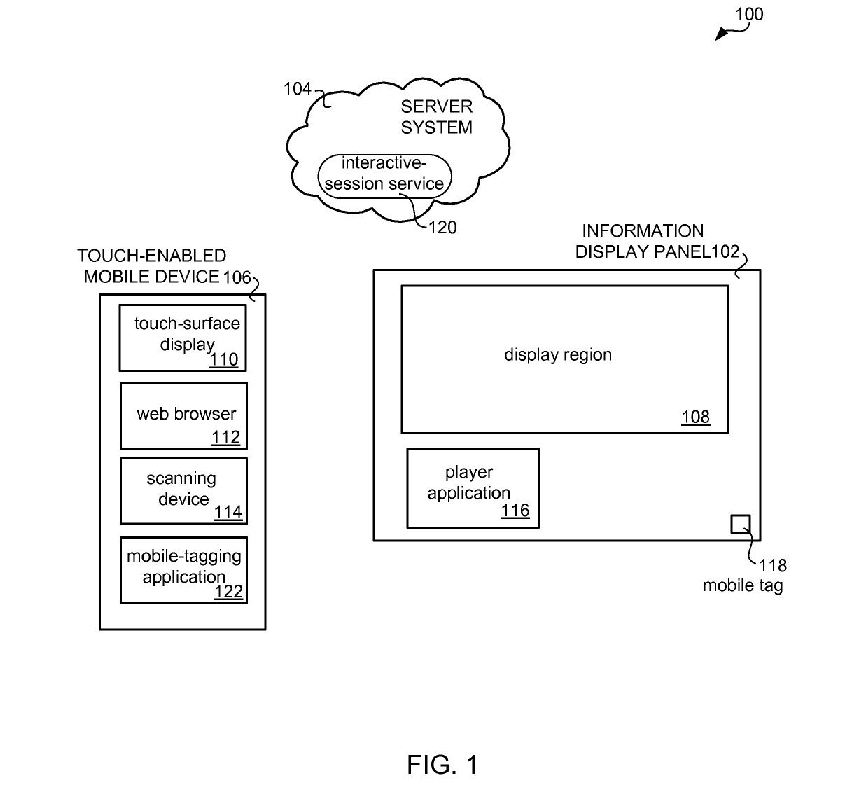

Some embodiments of the present invention may be understood in relation to FIG. 1. An interactive display system 100 may comprise an information display panel (IDP) 102, a server system 104, for example, a cloud server, a computer server and other server systems, and a touch-enabled mobile device 106. Touch gestures, for example, single-touch gestures, multi-touch gestures and other gestures, performed on the touch-enabled mobile device 106 may control the content displayed on the IDP 102.

In some embodiments of the present invention, touch-gesture information describing a touch gesture performed on the touch-enabled mobile device 106 may be communicated to the server system 104 from the touch-enabled mobile device 106. The server system 104 may translate the received touch-gesture information into IDP-domain touch-gesture information specific to the IDP 102. The IDP-domain touch-gesture information may be communicated from the server system 104 to the IDP 102. The IDP 102 may decode the received IDP-domain touch-gesture information and may effectuate changes to content displayed on the IDP 102 in accordance with the decoded IDP-domain touch-gesture information.

In some embodiments of the present invention, the IDP 102 may comprise a display region 108 in which digital content may be displayed. The touch-enabled mobile device 106 may comprise a touch-surface display 110. Exemplary touch-enabled mobile devices include a mobile phone, a tablet computing device, a personal digital assistant and other mobile devices comprising a touch-surface display on which content may be displayed and on which touch gestures may be made by a user and captured by the touch-enabled mobile device 106. The touch-enabled mobile device 106 may comprise a web browser 112 and a scanning device 114, for example, a camera, an optical scanner and other input devices capable of capturing visual information.

The IDP 102 may run a presentation, also considered a playlist or initial content, in a loop or other temporal configuration. The IDP 102 may comprise a player application 116, whereby initially running the player application 116 effectuates the display, in the display region 108 of the IDP 102, of the initial content. A user in possession of the touch-enabled mobile device 106 may view the initial content displayed, in the display region 108, on the IDP 102.

In some embodiments of the present invention, a mobile tag, for example, a Quick Response (QR) code, a Microsoft Tag or other 2-Dimensional (2D) barcodes and mobile tags used for mobile tagging, may be embedded in the initial content displayed on the IDP 102. In alternative embodiments, a mobile tag may be attached to the IDP 102. In yet alternative embodiments, a first mobile tag may be attached to the IDP 102, and a second mobile tag may be embedded in content displayed on the IDP 102. In some embodiments, the first mobile tag and the second mobile tag may be distinct. In alternative embodiments, the first mobile tag and the second mobile tag may be the same. In the exemplary embodiment depicted in FIG. 1, a mobile tag 118 is attached to the IDP 102.

When the mobile tag 118 bitmap is created, a link, for example, a Universal Resource Locator (URL) and other information-resource identifiers, to an interactive-session service 120 on the server system 104 may be embedded in the mobile tag 118. A unique identifier identifying the IDP 102 associated with the mobile tag 118, for example, either the IDP 102 on which the mobile tag 118 is affixed (as shown in FIG. 1) or the IDP on which the content, in which the mobile tag is embedded (not shown in FIG. 1), is displayed, may also be embedded in the mobile tag. In some embodiments in which the mobile tag is embedded in the content displayed on the IDP 102, the mobile tag may comprise an identifier associated with the content.

The user may scan, using the touch-enabled mobile device 106, the mobile tag 118. A mobile-tagging application 122 resident in the touch-enabled mobile device 106 may decode the mobile tag 118, and the touch-enabled mobile device 106 web browser 112 may be launched with the link to the interactive-session service 120 on the server system 104, thereby requesting an interactive session with the identified IDP 102. In some embodiments of the present invention, a first query string parameter for the link may be the unique identifier identifying the IDP 102.

The interactive-session service 120, upon receipt of the interactive-session request, may send a webpage, to the touch-enabled mobile device 106, that, when displayed on the touch-enabled mobile device 106 touch-surface display 110, may resemble a touch-pad found on a laptop computing device. In some embodiments of the present invention, a blank webpage may be displayed.

The user may interact with the IDP 102 using a touch gesture on the touch-surface display 110. Exemplary touch gestures include a single tap, a double tap, a single touch-point swipe, a two touch-point pinch, a two touch-point spread, a single touch-point directional swipe and other single-touch-point and multi-touch-point gestures. The webpage may capture one, or more, touch points and/or gestures made by the user and may send them to the interactive-session service on the server system 104. The captured touch points and/or gesture information may be referred to as touch-gesture information.

The interactive-session service 120 may translate, if required, received touch-gesture information to IDP-domain touch-gesture information. For example, touch-gesture information received at the interactive-session service 120 from the touch-enabled mobile device 106 may be translated to a format understood by the IDP 102. In some embodiments, the interactive-session service 120 may translate a received touch-point coordinate to a coordinate sized for the IDP 102.

The interactive-session service 120 may communicate the IDP-domain touch-gesture information to the IDP 102, and the player application 116 of the IDP 102 may effectuate the display of interactive-session content in the display region 108 of the IDP 102 by applying the received touch gestures and touch points. In some embodiments of the present invention, the entire display region 108 of the IDP 102 may be used for the interactive-session content. In alternative embodiments, a zone of the display region 108 may be used for the interactive-session content, while the remainder of the display region 108 may continue to display the initial content, scaled appropriately.

Visual feedback indicating a location, on the IDP display region 108, of a translated touch point may be displayed. In some embodiments, a translated touch point may be indicated by a colored circle drawn, on the content displayed on the IDP, at the location of the translated touch point. As a touch point moves, the location at which the colored circle is drawn may move. When a touch point ends, the last-drawn colored circle corresponding to the translated touch point may be removed from the displayed content.

In some embodiments of the present invention, the IDP player application may run an android-based playback application. In some of these embodiments, a FrameLayout may be used with a bitmap of different colors, wherein each touch device may be indicated by a unique color. The location where a touch point may be drawn on the FrameLayout may be changed and redrawn as new touch points are added and touch points are updated.

Exemplary interactive-session content may comprise moved, scaled, manipulated content on the IDP 102, new content, for example, additional details about a product associated with a touch point and other new content. Additionally, menu selections may be effectuated and selected regions may be closed, also considered exited.

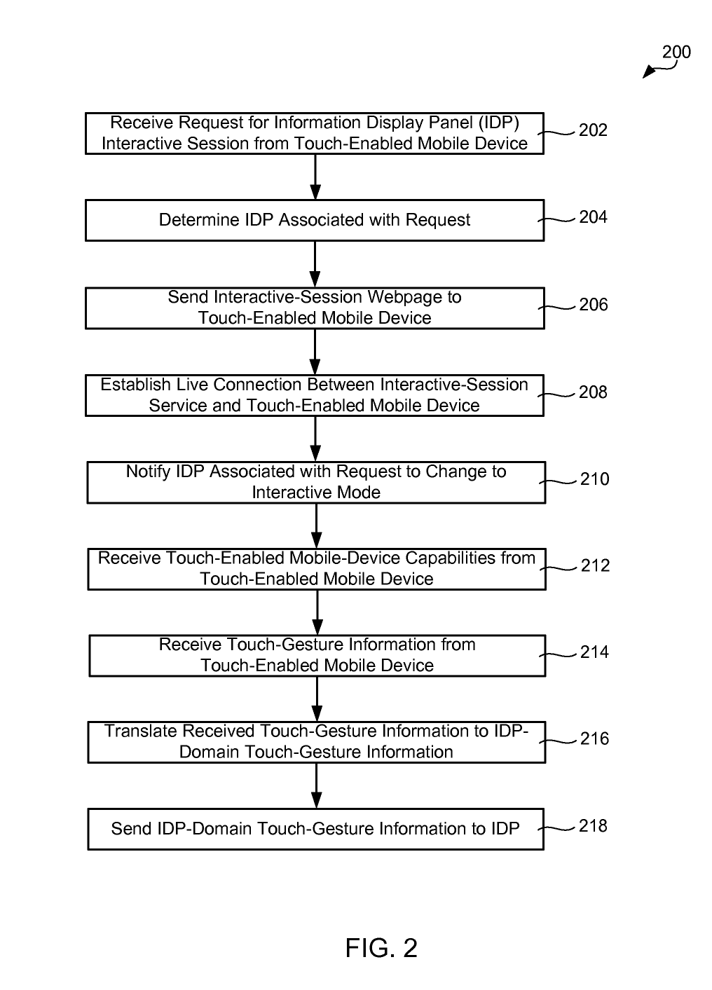

Some embodiments of the present invention may be described in relation to FIG. 2 which depicts a method(s) 200 for interacting with an IDP. An interactive-session service resident on a server system, for example, a cloud server, a computer server and other server systems, may receive 202, from a touch-enabled mobile device, a request for an IDP interactive session. The interactive-session service may be associated with a first link. The touch-enabled mobile device may use the first link to effectuate the request for the IDP interactive session. The interactive-session service may determine 204 an IDP associated with the request. In some embodiments of the present invention, one of the query string parameters for the first link may be associated with a parameter indicating for which IDP, from a plurality of IDPs, the request is related. A unique identifier associated with a first IDP may be extracted from the request.

The interactive-session service may send 206 an interactive-session webpage to the touch-enabled mobile device. The interactive-session webpage may comprise a display portion that when displayed on the touch-enabled mobile device may resemble a touch pad on a laptop, or other mobile computing device. The interactive-session webpage may further comprise a JavaScript.

The JavaScript, running on the touch-enabled mobile device, may initiate a live connection, wherein a socket connection may be maintained for the duration of the interactive session between the touch-enabled mobile device and the interactive-session service. In some embodiments of the present invention, the JavaScript may start a WebSocket connection to the interactive-session service, allowing a live socket connection for the web page for the duration of the connected session. In alternative embodiments, a polling ajax/REST model may be used wherein the web page may post updates through constant polling. The interactive-session service may accept the live socket connection thereby establishing 208 a live connection between the interactive-session service and the touch-enabled mobile device.

The interactive-session service may notify 210 the IDP identified as associated with the interactive-session request to change to an interactive mode.

When the interactive-session webpage opens on the touch-enabled mobile device, the JavaScript may communicate one, or more, capabilities of the touch-enabled mobile device to the interactive-session service. Exemplary capabilities may include touch-enabled mobile-device screen resolution, touch-enabled mobile-device screen size, touch-enabled mobile-device available touch points, touch-enabled mobile-device recognizable gestures and other capabilities.

The interactive-session service may receive 212 the touch-enabled mobile-device capabilities from the touch-enabled mobile device.

During the interactive session, the interactive-session service may receive 214 touch-gesture information from the touch-enabled mobile device. In some embodiments, as the user touches the webpage displayed on the touch-enabled mobile device, one, or more, touch points may be captured and sent to the interactive-session service. The interactive-session service may translate 216 the received touch-gesture information to IDP-domain touch-gesture information using the touch-enabled mobile device capabilities. For example, touch points received at the interactive-session service may be scaled to the dimensions of the display panel on the IDP. The IDP-specific touch-gesture information may be sent 218 to the IDP from the interactive-session service on the server system.

In some embodiments of the present invention, as the user touches the webpage on the touch-enabled mobile device, an HTMLS array of touch objects for every touch device, for example, a finger, a stylus, a pen and other tools used for interaction with a touch screen, currently touching the screen may be created. Each touch object may expose a plurality of properties, for example, the location with respect to the screen, page or HTML element. In some embodiments of the present invention, event handlers may be exposed, for example, touchStart, which may capture a starting point of a touch device touching the screen and may send it to the server system, touchMove, which may capture a touch trajectory associated with a touch device as the touch device moves on the touch screen and may send it to the server system, touchEnd, which may detect the removal of a touch device and may communicate the state change to the server system, gestureStart, which may capture and identify the start of a touch gesture and may communicate gesture information to the server system, gestureEnd, which may capture and identify the end of a touch gesture and may communicate it to the server system, and other event handlers.

Exemplary code for capturing a touch start point and sending it to the interactive-session service may comprise:

```
function onTouchStart(e) {
      touches = e.touches;
      if (e.touches.length >0) {
            var touch = e.touches[0];
            touchLoc = “tp:” + touch.clientX + “,” +
            touch.clientY + “,0”;
            sock.send(touchLoc);
}
```

where sock may be a WebSocket instance and .send( . . . ) may send a string that may comprise what is being sent, for example, “tp:” indicating a touch point, touch.clientX and touch.clientY indicating the touch-point-location coordinates and an indicator of whether it is start, move or end. In some embodiments, “0” may indicate start, “1” may indicate move and “2” may indicate end.

In some embodiments, the interactive-session service may pack the IDP-domain touch-gesture information using a standard data-framing layout, for example, as specified in the WebSocket WC3 protocol, wherein, the leading byte value is 0x00 followed by data which comprises Unicode characters encoded inUTF-8 and terminated with a trailing byte whose value is 0xFF.

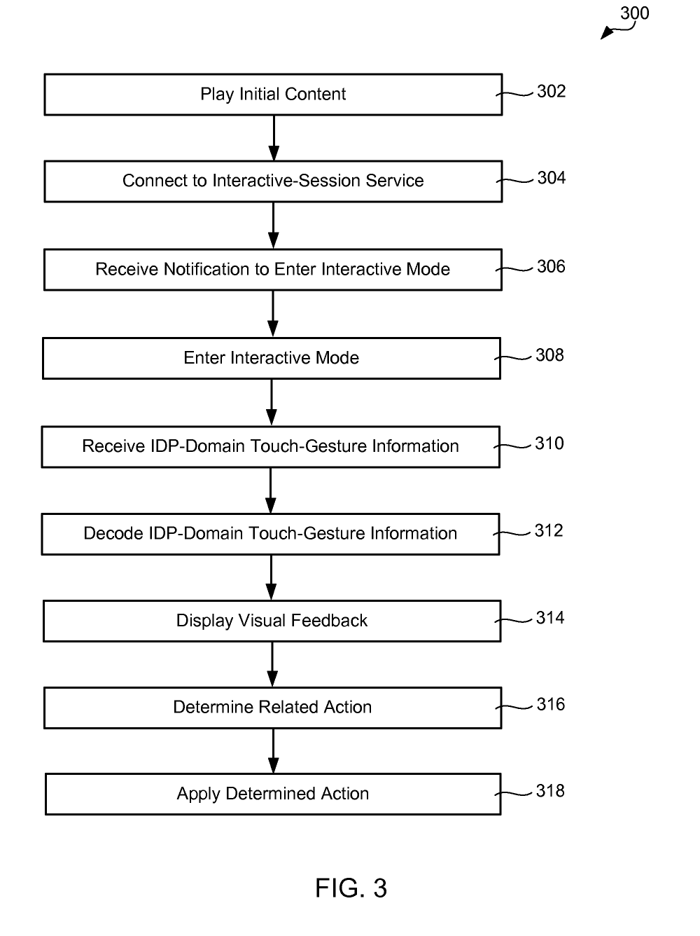

Some embodiments of the present invention may be described in relation to FIG. 3 which depicts a method(s) 300 for interacting with an IDP.

An IDP may play 302 initial content, displaying the initial content on the IDP in a display region. A player application may control the playing of the initial content. The initial content may be looped through in a slide show mode or a plurality of elements in a playlist may be played in a pre-programmed order. The IDP may connect 304 to an interactive-session service on a server system, for example, a cloud server, a computer server and other server systems. The player application may control the connection process. In some embodiments of the present invention, a simple web socket connection may be initiated when the player application starts up. In some embodiments, an open TCP connection may be maintained between the IDP and the server system on which the interactive-session service resides.

IDP-domain touch-gesture information, for example, touch points scaled to the IDP size, gesture information and other touch and gesture information, may be received 310 at the IDP from the server system. The IDP-domain touch-gesture information may be decoded 312 by the player application. If the decoded IDP-domain touch-gesture information comprises one, or more, touch points, then visual feedback indicating the location(s), on the IDP display region, of the touch points may be displayed 314. A touch point, scaled to the IDP domain, received in the IDP-domain touch-gesture information may be referred to as an IDP-domain touch point.

In some embodiments an IDP-domain touch point may be indicated by a colored circle drawn on the displayed images at the location of the IDP-domain touch point. As an IDP-domain touch point moves, the location at which the colored circle is drawn may move. When an IDP-domain touch point ends, the last-drawn colored circle corresponding to the IDP-domain touch point may be removed from the displayed images. In some embodiments of the present invention, the IDP player may run an android-based playback application. In some of these embodiments, a FrameLayout may be used with a bitmap of different colors, wherein each touch device is indicated by a unique color. The location where an IDP-domain touch point may be drawn on the FrameLayout may be changed and redrawn as new IDP-domain touch points are added and IDP-domain touch points are updated.

An action related to the decoded IDP-domain touch-gesture information may be determined 316 and applied 318. For example, content may be zoomed, translated, moved, changed and/or manipulated. For example, menu selections may be effectuated. For example, selected regions may be closed, also considered exited.

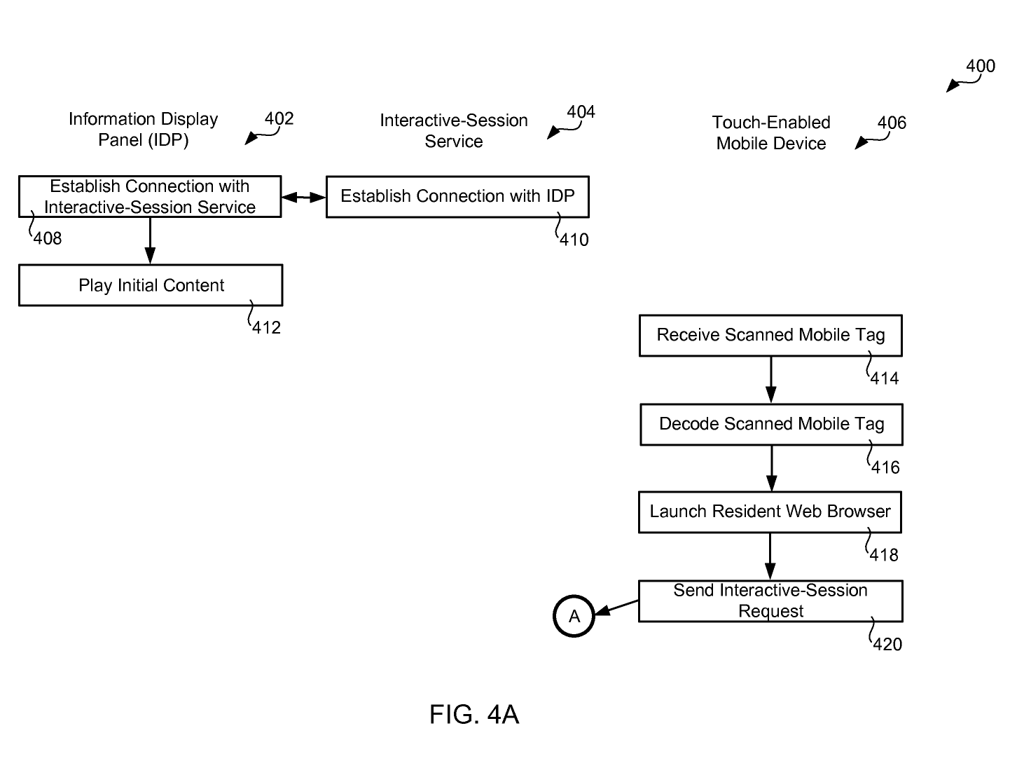

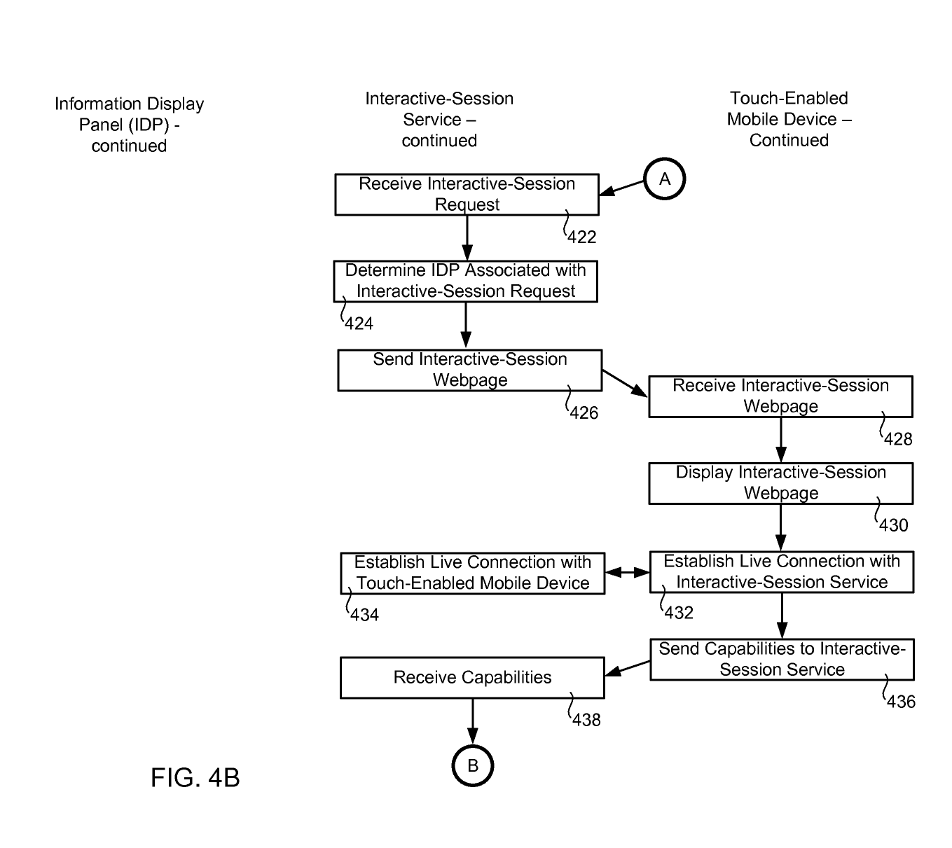

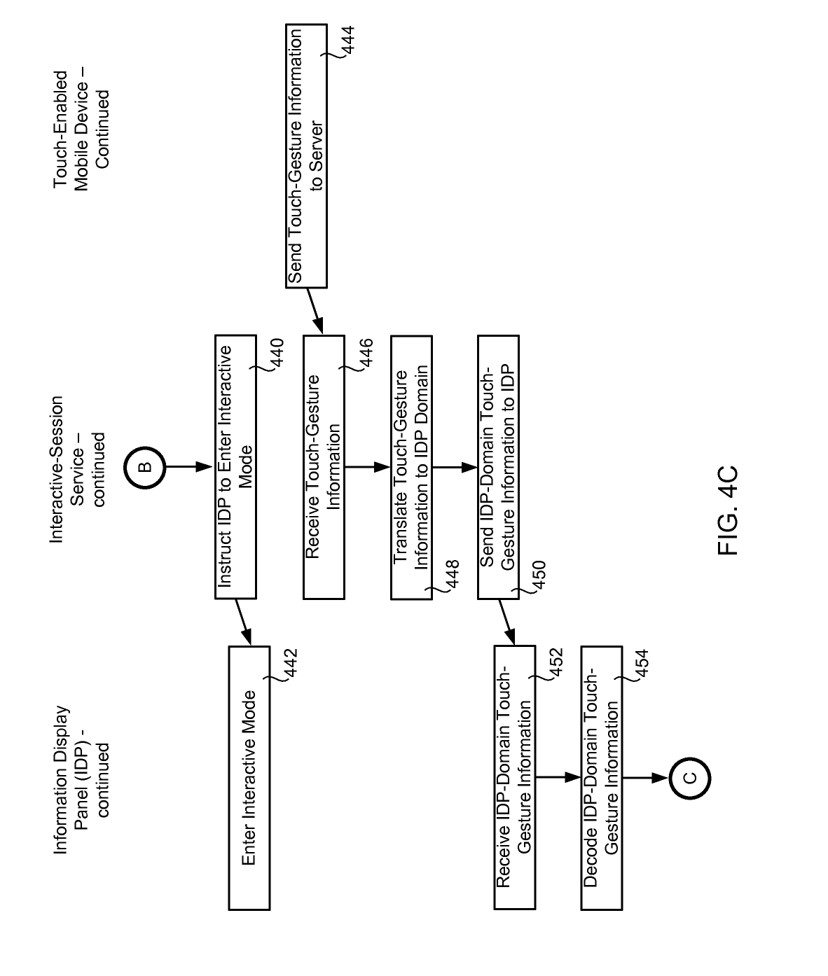

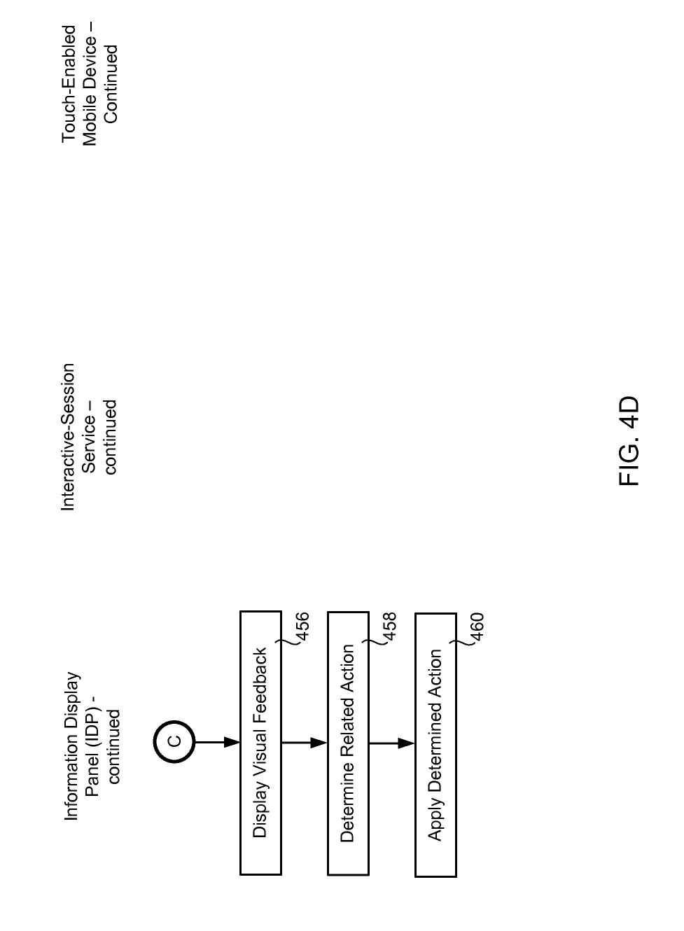

Some embodiments of the present invention may be understood in relation to FIG. 4. FIG. 4 depicts a method(s) 400 for interacting with an IDP. FIG. 4 illustrates the interaction between an IDP, a server system and a touch-enabled mobile device. The left-most column illustrates the IDP actions 402, the middle column illustrates the interactive-session service actions 404 and the right-most column illustrates the touch-enabled mobile device actions 406.

During the initiation of a player application that controls the playback of content on the IDP, a connection may be established 408, 410 between the IDP and an interactive-application service on the server system. The connection between the player application on the IDP and the interactive-application service on the server system may be maintained throughout the duration of the content playback and any interactive sessions. In some embodiments, a simple web socket connection may be initiated when the player application starts up. The IDP may play initial content 412, for example, the IDP may display a series of advertisements, a program, a slide show and/or other image or video content.

A user in possession of a touch-enabled mobile device may view the initial content on the IDP. In some embodiments of the present invention, a mobile tag, for example, a

Quick Response (QR) code, a Microsoft Tag and other 2D barcodes and mobile tags used for mobile tagging, may be embedded in the initial content displayed on the IDP. In alternative embodiments, a mobile tag may be attached to the IDP. In yet alternative embodiments, a first mobile tag may be attached to the IDP, and a second mobile tag may be embedded in the initial content displayed on the IDP. In some embodiments, the first mobile tag and the second mobile tag may be distinct. In alternative embodiments, the first mobile tag and the second mobile tag may be the same.

When the mobile tag bitmap is created, a link, for example, a Universal Resource Locator (URL) and other information-resource identifiers, to an interactive-session service on the server system may be embedded in the mobile tag. A unique identifier identifying the IDP associated with the mobile tag, for example, either the IDP on which the mobile tag is affixed or the IDP on which the content, in which the mobile tag is embedded, is displayed, may also be embedded in the mobile tag. In some embodiments in which the mobile tag is embedded in the content displayed on the IDP, the mobile tag may comprise an identifier associated with the content.

The touch-enabled mobile device may receive 414 a scanned mobile tag. In some embodiments, the touch-enabled mobile device may receive 414 the scanned mobile tag through a camera, scanner or other optical input device integral to the touch-enabled mobile device. A mobile-tagging application resident in the touch-enabled mobile device may decode 416 the mobile tag, and the touch-enabled mobile device web browser may be launched 418 with the link to the interactive-session service on the server system, thereby requesting 420 an interactive session with the identified IDP. In some embodiments of the present invention, a first query string parameter for the link may be the unique identifier identifying the IDP.

The interactive-session service, may receive 422, from the touch-enabled mobile device, the interactive-session request. The interactive-session service may determine 424 the IDP associated with the request.

The interactive-session service may send 426 an interactive-session webpage to the touch-enabled mobile device. The interactive-session webpage may comprise a display portion that when displayed on the touch-enabled mobile device may resemble a touch pad on a laptop, or other mobile computing device. The interactive-session webpage may further comprise a JavaScript.

The touch-enabled mobile device may receive 428 the interactive-session webpage. The web browser may display 430 the interactive-session webpage.

The JavaScript, running on the touch-enabled mobile device, may initiate 432 a live connection, wherein a socket connection may be maintained for the duration of the interactive session, between the touch-enabled mobile device and the interactive-session service.

In some embodiments of the present invention, the JavaScript may start a WebSocket connection to the interactive-session service, allowing a live socket connection for the web page for the duration of the connected session. In alternative embodiments, a polling ajax/REST model may be used wherein the web page may post updates through constant polling. The interactive-session service may accept the live socket connection thereby establishing 434 a live connection between the interactive-session service and the touch-enabled mobile device.

When the interactive-session webpage opens on the touch-enabled mobile device, the JavaScript may communicate 436 one, or more, capabilities of the touch-enabled mobile device to the interactive-session service. Exemplary capabilities may include touch-enabled mobile-device screen resolution, touch-enabled mobile-device available touch points, touch-enabled mobile-device recognizable gestures and other capabilities.

The interactive-session service may receive 438 the touch-enabled mobile-device capabilities from the touch-enabled mobile device.

The interactive-session service may instruct 440 the IDP identified as associated with the interactive-session request to change to an interactive mode. The IDP may enter 442 the interactive mode.

The user may interact with the IDP using a touch and/or multi-touch gesture on the touch-surface display. The webpage may capture touch-gesture information describing touch gestures made by the user and may send 444 them to the server system. The interactive-session service may receive 446 the touch-gesture information. The interactive-session service may translate 448 the received touch-gesture information to IDP-domain touch-gesture information using the touch-enabled mobile device capabilities. For example, touch points received at the interactive-session service may be scaled to the dimensions of the display panel on the IDP. The coordinates sized for the IDP and other touch-gesture information translated to the IDP domain may be referred to as IDP-domain touch-gesture information.

The interactive-session service may communicate 450 the IDP-domain touch-gesture information to the IDP. The IDP may receive 452 the IDP-domain touch-gesture information, and the player application of the IDP may decode 454 the IDP-domain touch-gesture information.

If the decoded IDP-domain touch-gesture information comprises one, or more, touch points, then visual feedback indicating the location(s), on the IDP display region, of the touch points may be displayed 456. A touch point, scaled to the IDP domain, received in the IDP-domain touch-gesture information may be referred to as an IDP-domain touch point.

In some embodiments an IDP-domain touch point may be indicated by a colored circle drawn on the displayed images at the location of the IDP-domain touch point. As an IDP-domain touch point moves, the location at which the colored circle is drawn may move. When an IDP-domain touch point ends, the last-drawn colored circle corresponding to the IDP-domain touch point may be removed from the displayed images. In some embodiments of the present invention, the IDP player may run an android-based playback application. In some of these embodiments, a FrameLayout may be used with a bitmap of different colors, wherein each touch device is indicated by a unique color. The location where an IDP-domain touch point may be drawn on the FrameLayout may be changed and redrawn as new IDP-domain touch points are added and IDP-domain touch points are updated.

In some embodiments, a touch point may be indicated by a colored circle drawn on the displayed images at the location of the touch point. As a touch point moves, the location at which the colored circle is drawn may move. When a touch point ends, the last-drawn colored circle corresponding to the touch point may be removed from the displayed images. In some embodiments of the present invention, the IDP player may run an android-based playback application. In some of these embodiments, a FrameLayout may be used with a bitmap of different colors, wherein each touch device is indicated by a unique color. The location where a touch point may be drawn on the FrameLayout may be changed and redrawn as new touch points are added and touch points are updated.

An action related to the decoded IDP-domain touch-gesture information may be determined 458 and applied 460. For example, content may be zoomed, translated, moved, changed and manipulated. For example, menu selections may be effectuated. For example, selected regions may be closed, also considered exited.

The above-listed examples are intended for illustration and not limitation.

Some embodiments of the present invention may comprise a computer program product comprising a computer-readable storage medium having instructions stored thereon/in which may be used to program a computing system, comprising at least one processor, to perform any of the features and methods described herein. Exemplary computer-readable storage media may include, but are not limited to, flash memory devices, disk storage media, for example, floppy disks, optical disks, magneto-optical disks, Digital Versatile Discs (DVDs),

Compact Discs (CDs), micro-drives and other disk storage media, Read-Only Memory (ROMs), Programmable Read-Only Memory (PROMs), Erasable Programmable Read-Only Memory (EPROMS), Electrically Erasable Programmable Read-Only Memory (EEPROMs), Random-Access Memory (RAMS), Video Random-Access Memory (VRAMs), Dynamic Random-Access Memory (DRAMs) and any type of media or device suitable for storing instructions and/or data.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for interacting with an information display panel (IDP) said method comprising:
receiving, at an interactive-session service from a touch-enabled mobile device, touch-gesture information;
translating said received touch-gesture information into IDP-domain touch-gesture information specific to an information display panel; and
sending said IDP-domain touch-gesture information to said information display panel from said interactive-session service.

2. A method as described in claim 1, wherein said touch-enabled mobile device sends said touch-gesture information to said interactive-session service.

3. A method as described in claim 1, wherein said interactive-session service resides on a server system.

4. A method as described in claim 1, wherein:
said received touch-gesture information comprises a first touch-point location; and
said translating comprises scaling said first touch-point location based on a relative measure of a touch-enabled mobile-device touch-surface-display resolution to an IDP display-region resolution.

5. A method as described in claim 4 further comprising receiving, at said interactive-session service from said touch-enabled mobile device, a touch-enabled mobile-device capability comprising said touch-enabled mobile-device touch-surface-display resolution.

6. A method as described in claim 1 further comprising receiving, at said interactive-session service, an interactive-session request from said touch-enabled mobile device.

7. A method as described in claim 6, wherein said interactive-session request comprises a unique identifier associated with said information display panel.

8. A method as described in claim 1 further comprising sending, from said interactive-session service to said touch-enabled mobile device, an interactive-session webpage.

9. A method as described in claim 1 further comprising notifying said information display panel to change to an interactive mode.

10. A method as described in claim 9 further comprising:
receiving, at said information display panel, said notification to change to said interactive mode; and
changing said information display panel to said interactive mode.

11. A method as described in claim 1 further comprising:
receiving, at said interactive-session service from said touch-enabled mobile device, at least one capability of said touch-enabled mobile device; and
wherein said translating uses said at least one capability.

12. A method as described in claim 1 further comprising:
receiving said IDP-domain touch-gesture information at said information display panel;
decoding said received IDP-domain touch-gesture information; and
effectuating changes to content displayed on said information display panel in accordance with said decoded IDP-domain touch-gesture information.

13. A method as described in claim 12, wherein said effectuating changes comprises:
displaying visual feedback based on said decoded IDP-domain touch-gesture information;
determining an action from said decoded IDP-domain touch-gesture information; and
applying said determined action.

14. A method for interacting with an information display panel (IDP), said method comprising:
at an information display panel:
playing initial content;
connecting to an interactive-session service;
receiving, from said interactive-session service, a notification to enter an interactive mode;
changing to said interactive mode;
receiving IDP-domain touch-gesture information specific to said information display panel from said interactive-session service;
decoding said IDP-domain touch-gesture information;
displaying visual feedback based on said decoded IDP-domain touch-gesture information;
determining an action from said decoded IDP-domain touch-gesture information; and
applying said determined action.

15. A method as described in claim 14 further comprising:
at said interactive-session service:
sending said notification, to said information display panel, to enter said interactive mode.

16. A method as described in claim 14 further comprising:
at said interactive-session service:
receiving, from a touch-enabled mobile device, touch-gesture information;
translating said received touch-gesture information into said IDP-domain touch-gesture information specific to said information display panel; and
sending said IDP-domain touch-gesture information to said information display panel.

17. A method described in claim 14 further comprising:
at said interactive-session service:
receiving, from a touch-enabled mobile device a request for an interactive session.

18. A method as described in claim 17, wherein said interactive-session request comprises a unique identifier associated with said information display panel.

19. A method as described in claim 17 further comprising said touch-enabled mobile device sending to said interactive-session service said touch-gesture information.

20. A system for interacting with an information display panel (IDP), said system comprising:
an interactive-session service for:
receiving, from a touch-enabled mobile device, touch-gesture information;
translating said received touch-gesture information into IDP-domain touch-gesture information specific to an information display panel; and
sending said IDP-domain touch-gesture information to said information display panel; and
said information display panel for:
receiving said IDP-domain touch-gesture information;
decoding said received IDP-domain touch-gesture information; and
effectuating changes to content displayed on said information display panel in accordance with said decoded IDP-domain touch-gesture information.

21. A system as described in claim 20 further comprising said touch-enabled mobile device.
